(19) United States
(12) Patent Application Publication
(10) Pub. No.: US 2009/0292479 A1
(43) Pub. Date: Nov. 26, 2009

(54) METHOD FOR ANALYZING IMAGE FROM BIO-DETECTION ANALYZER

(75) Inventors: Tsung-kai Chuang, Tainan City (TW); Tzu-chiang Wu, Tainan City (TW); Jiann-hua Wang, Taipei (TW)

Correspondence Address: KIRTON AND MCCONKIE, 60 EAST SOUTH TEMPLE,, SUITE 1800, SALT LAKE CITY, UT, 84111, US

(73) Assignee: KAIWOOD TECHNOLOGY CO., LTD., Hsin-Shi (TW)

(21) Appl. No.: 12/126,599

(22) Filed: May 23, 2008

(51) Int. Cl. G06F 19/00

(52) U.S. Cl. 702/19

(57) ABSTRACT

A method for analyzing an image from a bio-detection analyzer includes steps of: illuminating a reacted bio-detection carrier having at least one detection spot and at least one positioning spot by at least one light source; capturing a single image of the bio-detection carrier having all of detection-spot images and positioning-spot images by an image capturing unit; defining a reference coordinate location of each of the detection-spot images according to the positioning-spot image; defining an effective detection area of each of the detection-spot images according to the reference coordinate location of each of the detection-spot images; and analyzing an averaged intensity value (such as an averaged gray scale value) of each of the detection-spot images, so as to output the averaged intensity value for showing a reaction result of the reacted bio-detection carrier.

### FIELD OF THE INVENTION

The present invention relates to a method for analyzing an image from a bio-detection analyzer, and more particularly to a method for analyzing an image from a bio-detection analyzer which captures a single image of a reacted bio-detection carrier for directly executing an image positioning process and an image intensity analysis, so as to speedily output detection result.

### BACKGROUND OF THE INVENTION

A so-called biochip is a detecting analysis tool having a compact area and high distribution density. According to a classification and a use of a biochip, it can provide various detecting analysis modes based on a molecular biological principle, an analytically chemical principle, or a bio-chemical reaction principle. Thus, there is a considerable potential and value for using the biochip in technological fields of medical therapy or bio-chemical detection. Furthermore, different biochips may provide different related biological molecules (such as gene fragments, proteins, organic compounds, or cell tissues) as detection probes which can be precisely dropped or flowed on a carrier based on micro-fluidic, micro-array, or micro-electromechanical technologies. The carrier can be selected from a substrate of glass, silicon, polycarbonate (PC), or poly(methyl methacrylate) (i.e. PMMA), paper, and etc. The biochip is gradually applied to various applications, because it can provide a compact carrier area which only needs a few of sample or reagent for simultaneously and speedily executing a large number of detection processes. Generally, the sample (i.e. a detected object) can be selected from nucleic acid or protein. After the sample is reacted and linked to the detection probes on the carrier, the detection probes must be processed by a suitable tag reagent, such as a fluorescent tag, a chemi-luminescent tag, or a colorimetric tag, so as to detect if any reaction is reacted in the biochip in a certain degree.

In order to obtain a detection result of the reaction of the biochip and the sample, related manufacturers develop various bio-detection analyzers to conveniently and speedily provide data of detection results for further executing a digitally analysis comparison of the data. Presently, a traditional bio-detection analyzer generally provides a camera for capturing each image section of each of detection spots on a reacted biochip in turn, and then executes an image analysis process to the image section of each of the detection spots in turn, in order to obtain a bio-detection result of the reacted biochip. However, the foregoing detection procedure of the traditional bio-detection analyzer wastes a lot of time and is complicated, resulting in lowering the detection efficiency. Meanwhile, the traditional bio-detection analyzer must further provide a motion unit to move the camera or the biochip, resulting in complicating the entire structure of the analyzer.

For example, Taiwan Invention Pat. No. 1247108, entitled “Biochip Detection Analyzer” disclosed a traditionally optical detection device which comprises a control system controlling a continuous laser emitted by a laser system, wherein the laser is reflected and projected to an array detection sample on a base. Meanwhile, the control system further controls a two-dimensional motion platform, so that the laser can be precisely projected to the array detection sample. Hence, the laser is illuminated on detection substance of a plurality of detection spots on the array detection sample, and reflected to generate a radiation light. Then, the radiation light is projected, reflected, filtered, and focused to generate an image on a signal reading device, so as to read light signals transmitted from each of the detection spots on the array detection sample.

As described above, there are similar technological problems existing in the traditionally optical detection device, as follows: In detection operation, the device continuously scans each of the detection spots in turn by a two-dimensional motion mode, resulting in wasting too much scanning time. Moreover, only when the array detection sample is positioned on the base and moved by the two-dimensional motion platform, the laser can be precisely aligned with and projected to each of the detection spots on the array detection sample. Meanwhile, because the laser is continuously emitted, the laser system consumes too much power, and a noise signal may generate in the light signal and can not be separated therefrom. Furthermore, the array detection sample is continuously moved, so that a vibrational noise signal may be generated in the image, and the array detection sample may be damaged. As a result, the entire structure of the traditionally optical detection device is complicated, and the volume thereof occupies too much space.

In addition, the '108 patent further disclosed another optical detection device to improve the technological problems of the two-dimensional motion mode, wherein the optical detection device comprises a light source guiding module which has an array light source and a light guiding element. The array light source emits an area light source which is converted into a linear light source through the light guiding element and outputted for a scanning purpose. The array light source is constructed by a plurality of light emitting diodes (LEDs) to replace the signal laser light source. Furthermore, a base is used to support an array detection sample, and can be moved in a one-dimensional motion mode for scanning, so as to replace the traditionally two-dimensional motion mode of the traditionally optical detection device.

However, in detection operation, the optical detection device continuously and linearly scans each of the detection spots in turn by the one-dimensional motion mode for capturing a plurality of linear images of a plurality of the detection spots, resulting in wasting too much scanning time. Moreover, the array detection sample must be positioned on the base, and moved by the one-dimensional motion platform. Although the motion frequency is lowered, it may still cause a position deviation when scanning the image in each motion. Thus, the device must continuously correct the position of each of the images, or the accuracy of the detection result cannot be ensured. Furthermore, the array detection sample is continuously moved, so that a vibrational noise signal may be generated in the image, and the array detection sample may be damaged. As a result, the entire structure and procedure of the optical detection device are still complicated.

As a result, it is important for related manufacturers to think how to develop a method for analyzing an image from a bio-detection analyzer to improve the technological problems existing in the traditionally optical detection device.

### SUMMARY OF THE INVENTION

A primary object of the present invention is to provide a method for analyzing an image from a bio-detection analyzer, wherein a single image of a reacted bio-detection carrier is captured for directly executing an image positioning process, an area calculation process, and an intensity analysis process, so as to simplify the entire structure, enhance the detection efficiency, lower the detection cost, and increase the detection convenience.

A secondary object of the present invention is to provide a method for analyzing an image from a bio-detection analyzer, wherein at least one positioning spot is formed on a bio-detection carrier in advance for executing an image positioning process to obtain a reference coordinate location of each of detection spots on the bio-detection carrier, so as to increase the detection accuracy.

A third object of the present invention is to provide a method for analyzing an image from a bio-detection analyzer, wherein an image area calculation process is executed after positioning the detection spots on the bio-detection carrier, for obtaining an effective detection area of each of detection spots, so as to increase the detection reliability.

A fourth object of the present invention is to provide a method for analyzing an image from a bio-detection analyzer, wherein an image intensity analysis process is executed after obtaining the effective detection area of each of detection spots, for outputting an averaged intensity value of each of detection spots, so as to increase the detection objectivity.

To achieve the above object, a method for analyzing an image from a bio-detection analyzer of a preferred embodiment of the present invention comprises steps of: illuminating a reacted bio-detection carrier having at least one detection spot and at least one positioning spot by at least one light source; capturing a single image of the bio-detection carrier having all of detection-spot images and positioning-spot images by an image capturing unit; defining a reference coordinate location of each of the detection-spot images according to the positioning-spot image; defining an effective detection area of each of the detection-spot images according to the reference coordinate location of each of the detection-spot images; and analyzing an averaged intensity value (such as an averaged gray scale value) of each of the detection-spot images, so as to output the averaged intensity value for showing a reaction result of the reacted bio-detection carrier.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of a method for analyzing an image from a bio-detection analyzer according to a first preferred embodiment of the present invention;

FIG. 2 is a schematic view of a bio-detection analyzer according to the first preferred embodiment of the present invention;

FIGS. 3A, 3B, and 3C are schematic views of various bio-detection carriers according to the first preferred embodiment of the present invention;

FIG. 4 is a schematic view of a single image of the bio-detection carrier according to the first preferred embodiment of the present invention;

FIG. 5 is a schematic view of a bio-detection analyzer according to a second preferred embodiment of the present invention;

FIG. 6 is a schematic view of a bio-detection analyzer according to a third preferred embodiment of the present invention; and

FIG. 7 is a schematic view of a bio-detection analyzer according to a fourth preferred embodiment of the present invention.

### DETAILED DESCRIPTION OF THE PREFERRED EMBODIMENTS

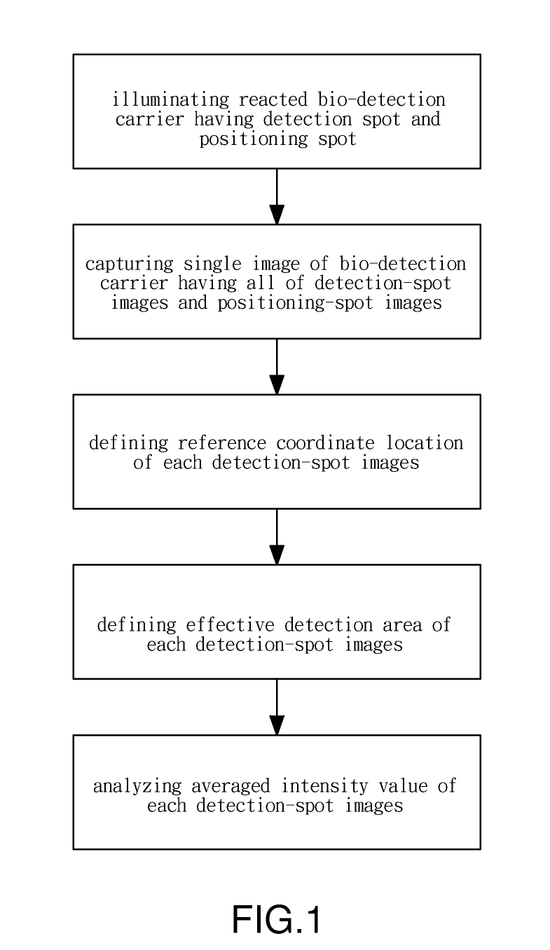

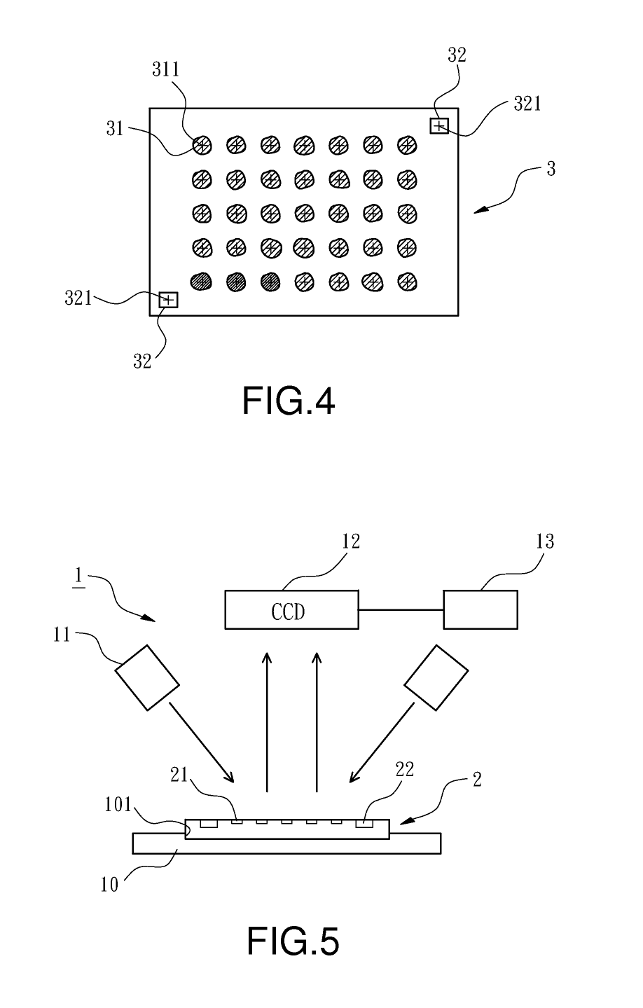

Referring now to FIGS. 1, 2, 3, and 4, a method for analyzing an image from a bio-detection analyzer according to a first preferred embodiment of the present invention is illustrated. As shown, the method comprises steps of: illuminating a reacted bio-detection carrier 2 having at least one detection spot 21 and at least one positioning spot 22 by at least one light source 11; capturing a single image 3 of the bio-detection carrier 2 having all of detection-spot images 31 and positioning-spot images 32 by an image capturing unit 12; defining a reference coordinate location 311 of each of the detection-spot images 31 according to the positioning-spot image 32; defining an effective detection area of each of the detection-spot images 31 according to the reference coordinate location 311 of each of the detection-spot images 31; and analyzing an averaged intensity value (such as an averaged gray scale value) of each of the detection-spot images 31, so as to output the averaged intensity value for showing a reaction result of the reacted bio-detection carrier 2.

The method for analyzing the image of the present invention will be described more detailed by various bio-detection analyzers of the four preferred embodiments of the present invention hereinafter, but the method for analyzing the image of the present invention is not limited to the structure of the bio-detection analyzers.

Referring still to FIGS. 1, 2, 3, and 4, the first step of the method for analyzing the image from the bio-detection analyzer according to the first preferred embodiment of the present invention is carried out by illuminating the reacted bio-detection carrier 2 having the at least one detection spot 21 and the at least one positioning spot 22 by the at least one light source 11. The first preferred embodiment of the present invention provides a bio-detection analyzer 1 which comprises a support base 10, the at least one light source 11, the image capturing unit 12, and an image processor 13. The support base 10 is used to support the bio-detection carrier 2, and preferably provided with at least one positioning recess 101 (or at least one positioning protrusion, not-shown) for initially positioning the bio-detection carrier 2. In the first preferred embodiment of the present invention, the light source 11 is disposed below the support base 10, and the support base 10 is preferably made of transparent material, such as glass or plastic. According to the classification of the bio-detection analyzer 1, the light source 11 can be selected from a daylight lamp, a fluorescent lamp, a laser light source, or a light emitting diode (LED) light source, for providing a light having a suitable frequency. The image capturing unit 12 can be selected from a charge coupled device (CCD) sensor or a complementary metal-oxide semiconductor (CMOS) sensor, and is disposed above the support base 10. The image processor 13 is electrically connected to the image capturing unit 12. The image processor 13 can be selected from desktop computer, notebook computer, or server computer, and used to provide various image processing functions for the image positioning process and the intensity analysis process in the following steps which will be described hereinafter. Furthermore, the bio-detection analyzer 1 can be preferably provided with a plurality of lenses or reflection mirrors (not-shown) between the light source 11 and the image capturing unit 12 for suitably expanding, concentrating, refracting, or reflecting the light of the light source 11.

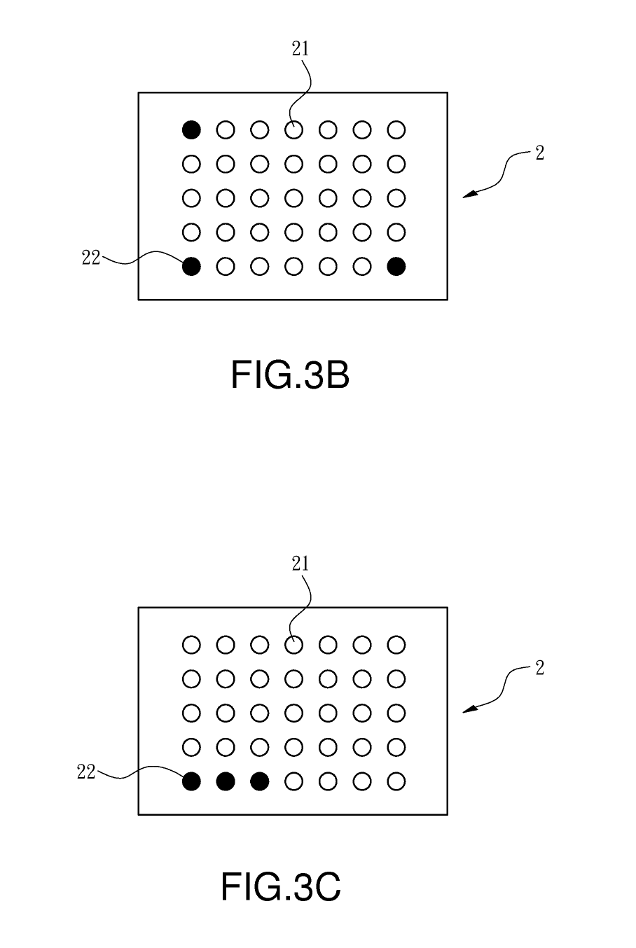

In addition, referring now to FIGS. 3A, 3B, and 3C, in the first preferred embodiment of the present invention, the bio-detection carrier 2 can be selected from various bio-detection assay papers or biochips according to the application of the bio-detection analyzer 1, wherein the bio-detection assay paper or biochip must be able to generate color variation after be reacted. For example, the bio-detection assay paper or biochip can be selected from immunoblot assay paper, DNA genetic biochip, protein biochip, micro-array biochip, micro-fluidic biochip, or micro-electromechanical biochip, while the substrate thereof may be paper, plastic, silicon wafer, metal, or other macro-molecular polymer material. The bio-detection carrier 2 is provided with the at least one detection spot 21 and the at least one positioning spot 22. The detection spot 21 is suitably arranged on the bio-detection carrier 2, such as an array arrangement. Each of the detection spots 21 is dropped with a suitable detection probe in advance, so that it can generate color degree variation after be reacted. The coloration principle of the detection probe can be selected from a colorimetric tag, a fluorescent tag, or a chemi-luminescent tag. Furthermore, the positioning spot 22 is disposed on other suitable location of the bio-detection carrier 2 excluding the detection spot 21. For example, the positioning spot 22 can be disposed on at least one corner or at least one side edge of the bio-detection carrier 2 by a suitable mode, such as high-concentration dye spot, high-concentration fluorescent tag, protrusion, recess, or printing, so as to provide a reference coordinate for positioning each of the detection spots 21.

Moreover, referring still to FIGS. 3A, 3B, and 3C, in the first preferred embodiment of the present invention, the number of the positioning spot 22 is preferably two or more than two according to actual needs. The arrangement relationship of the positioning spots 22 can be selected from a cross positioning arrangement, a triangular positioning arrangement, or a tri-point positioning arrangement for executing the positioning analysis in the following step. For example, referring to FIG. 3A, two of the positioning spots 22 are disposed on two diagonal corners of the bio-detection carrier 2 by a suitable mode, respectively, for providing a cross positioning arrangement. Referring to FIG. 3B, three of the positioning spots 22 are disposed on three corners of the bio-detection carrier 2 by a suitable mode, respectively, for providing a triangular positioning arrangement. Referring to FIG. 3C, three of the positioning spots 22 are disposed on three continuous spots in the same row (or column) of the bio-detection carrier 2 by a suitable mode, respectively, for providing a tri-point positioning arrangement. In the four preferred embodiments of the present invention, the bio-detection carrier 2 as shown in FIG. 3A is exemplified to describe the method for analyzing an image from a bio-detection analyzer of the present invention. However, the foregoing positioning arrangements of the bio-detection carrier 2 are only possible embodiments of the present invention without limitation, while the method for analyzing an image from a bio-detection analyzer of the present invention can be applied to other the bio-detection carrier 2 having different positioning arrangement.

Referring back to FIGS. 1, 2, 3, and 4, the second step of the method for analyzing the image from the bio-detection analyzer according to the first preferred embodiment of the present invention is carried out by capturing a single image 3 of the bio-detection carrier 2 having all of detection-spot images 31 and positioning-spot images 32 by the image capturing unit 12. In the second step, the image capturing unit 12 is used to collect light from the bio-detection carrier 2 on the support base 10, in order to capture the single image 3 of the bio-detection carrier 2 and transmit the single image 3 to the image processor 13. The image 3 comprises all of the detection-spot images 31 and the positioning-spot images 32, each of which is corresponding to the detection spots 21 and the positioning spots 22 of the bio-detection carrier 2, respectively. Furthermore, in order to reduce noise signal in the image 3, the image capturing unit 12 only captures an image within a range of the bio-detection carrier 2 excluding an outermost edge image of the bio-detection carrier 2 and an external image outside the range of the bio-detection carrier 2. Alternatively, the image processor 13 can reduce noise signal by other method, such as installing a diffusion plate (not-shown) on the light source 11 for enhancing the light evenness thereof.

Referring still to FIGS. 1, 2, 3, and 4, the third step of the method for analyzing the image from the bio-detection analyzer according to the first preferred embodiment of the present invention is carried out by defining a reference coordinate location 311 of each of the detection-spot images 31 according to the positioning-spot image 32. In the third step, the image processor 13 of the bio-detection analyzer 1 provides a function of image positioning process, wherein a comparison sample image (not-shown) is saved in the image processor 13 in advance for being compared with the image 3. The comparison sample image includes samples of the detection-spot images 31 and the positioning-spot image 32. Thus, once the image processor 13 correctly determines a reference coordinate location 321 of the positioning-spot image 32 of the image 3 according to the comparison sample image, the image processor 13 will correctly identify the reference coordinate location 311 of each of the detection-spot image 31 of the image 3 according to the reference coordinate location 321 of the positioning-spot image 32. If there is a distance deviation between an actual coordinate location of the positioning-spot image 32 of the image 3 and a predetermined positioning-spot location of the comparison sample image, the image processor 13 will search an adjacent region of the originally predetermined positioning-spot location in the image 3, in order to find the actual coordinate location of the positioning-spot image 32 in the image 3. The reference coordinate location 311 of each of the detection-spot image 31 and the reference coordinate location 321 of the positioning-spot image 32 preferably represent a location of a predetermined geometric center or a range of a predetermined maximum detection area.

Referring back to FIGS. 1, 2, 3, and 4, the fourth step of the method for analyzing the image from the bio-detection analyzer according to the first preferred embodiment of the present invention is carried out by defining an effective detection area of each of the detection-spot images 31 according to the reference coordinate location 311 of each of the detection-spot images 31. After the reference coordinate location 311 of each of the detection-spot images 31 provides the location of the predetermined geometric center or the range of the predetermined maximum detection area, the image processor 13 of the bio-detection analyzer 1 provides a function of image area calculation process for defining an actually effective detection area of each of the detection-spot images 31. In fact, because each of the detection spots 21 may be unevenly dropped with the detection probe or unevenly dyed, the actually effective detection area thereof may be equal to or smaller than a predetermined maximum detection area. According to a predetermined intensity variation standard, the image processor 13 can define an outermost boundary of each of the detection spots 21, so as to calculate the actually effective detection area thereof.

Referring back to FIGS. 1, 2, 3, and 4, the fifth step of the method for analyzing the image from the bio-detection analyzer according to the first preferred embodiment of the present invention is carried out by analyzing an averaged intensity value (such as an averaged gray scale value) of each of the detection-spot images 31, so as to output the averaged intensity value. In the fifth step, the image processor 13 of the bio-detection analyzer 1 provides a function of intensity calculation process for sampling a predetermined number of sampling points in per predetermined area unit, in order to obtain a plurality of intensity values (such as a gray scale value). In other words, the image processor 13 can sample a plurality of sampling points (or all of the sampling points) from the actually effective detection area of each of the detection spots 21, so as to obtain a plurality of intensity values, wherein the intensity values is selected from one of 256 levels of a gray scale, which is varied from complete black (level 0) to complete white (level 255). Then, the image processor 13 executes an average calculation to the plurality of the intensity values, so as to generate an averaged intensity value of each of the detection spots 21. The averaged intensity value can be temporarily saved in a storage unit (such as hard disk, not-shown) of the image processor 13, or outputted to other external device (such as another computer) via a suitable means (such as a network). As a result, the external device can determine the bio-detection result of the reacted bio-detection carrier 2 according to the averaged intensity value of each of the detection spots 21.

According to the first to fifth steps of the first preferred embodiment of the present invention, the single image 3 of the reacted bio-detection carrier 2 is captured for directly executing an image positioning process, an area calculation process, and an intensity analysis process, so as to be advantageous to simplify the entire structure, enhance the detection efficiency, lower the detection cost, and increase the detection convenience. Furthermore, the at least one positioning spot 22 is formed on the bio-detection carrier 2 in advance for executing an image positioning process to obtain a reference coordinate location of each of the detection spots 21 on the bio-detection carrier 2, so as to be advantageous to increase the detection accuracy. Moreover, after positioning the detection spots 21 on the bio-detection carrier 2, an image area calculation process is executed for obtaining an effective detection area of each of the detection spots 21, so as to be advantageous to increase the detection reliability. After obtaining the effective detection area of each of the detection spots 21, an image intensity analysis process is executed for outputting an averaged intensity value of each of the detection spots 21, so as to be advantageous to increase the detection objectivity.

Referring now to FIG. 5, a method for analyzing an image from a bio-detection analyzer according to a second preferred embodiment of the present invention is illustrated. As shown, the method of the second preferred embodiment is similar to that of the first preferred embodiment, while a bio-detection analyzer 1 of the second preferred embodiment is different from that of the first preferred embodiment. Although the bio-detection analyzer 1 of the second preferred embodiment comprises a support base 10, at least one light source 11, an image capturing unit 12, and an image processor 13, the light source 11 is obliquely disposed above at least one side of the support base 10. Meanwhile, the image capturing unit 12 is disposed above the support base 10. The light source 11 emits a light which will be obliquely projected to the bio-detection carrier 2 on the support base 10. Then, the light is reflected from the bio-detection carrier 2 and projected upward to the image capturing unit 12. Furthermore, the bio-detection analyzer 1 can be preferably provided with a plurality of lenses or reflection mirrors (not-shown) between the light source 11 and the image capturing unit 12 for suitably expanding, concentrating, refracting, or reflecting the light of the light source 11. As a result, the method for analyzing an image from a bio-detection analyzer of the present invention can be applied to the bio-detection analyzer 1 of the second preferred embodiment having different structure from the first preferred embodiment.

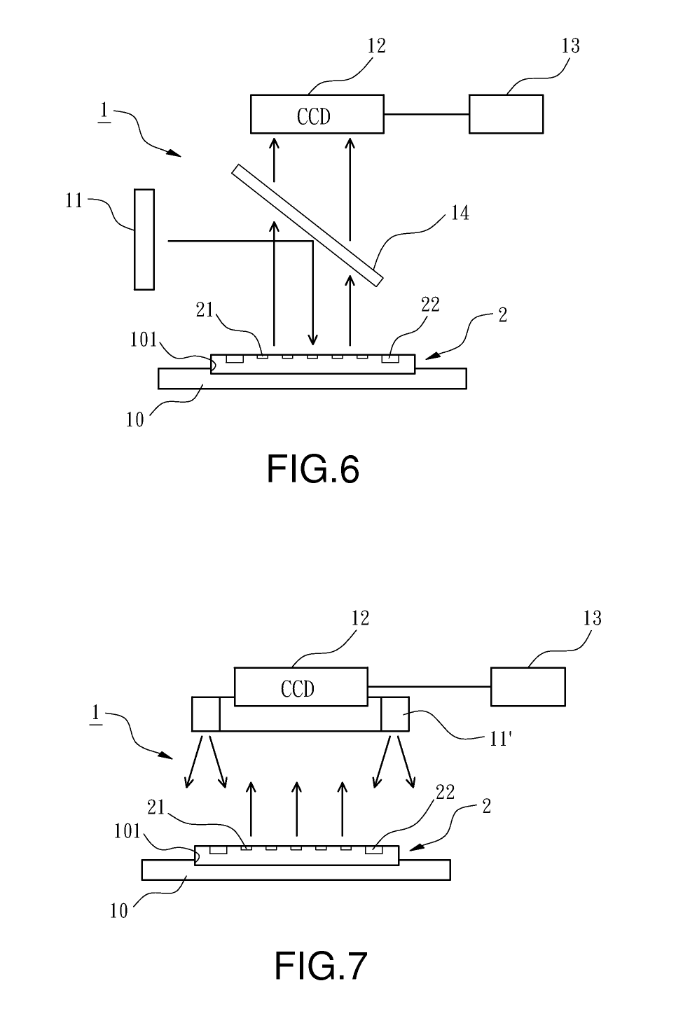

Referring now to FIG. 6, a method for analyzing an image from a bio-detection analyzer according to a third preferred embodiment of the present invention is illustrated. As shown, the method of the third preferred embodiment is similar to that of the first preferred embodiment, while a bio-detection analyzer 1 of the third preferred embodiment is different from that of the first preferred embodiment. The bio-detection analyzer 1 of the third preferred embodiment comprises a support base 10, at least one light source 11, an image capturing unit 12, an image processor 13, and a beam splitter mirror 14, wherein the light source 11 is disposed above one side of the support base 10. Meanwhile, the image capturing unit 12 is disposed above the support base 10. The beam splitter mirror 14 is a semi-transmission mirror. The light source 11 horizontally emits a light to the beam splitter mirror 14, and then the light will be reflected and projected downward to the bio-detection carrier 2 on the support base 10. Meanwhile, the light is reflected from the bio-detection carrier 2, transmitted through the beam splitter mirror 14, and projected upward to the image capturing unit 12. Furthermore, the bio-detection analyzer 1 can be preferably provided with a plurality of lenses or reflection mirrors (not-shown) between the light source 11 and the image capturing unit 12 for suitably expanding, concentrating, refracting, or reflecting the light of the light source 11. As a result, the method for analyzing an image from a bio-detection analyzer of the present invention can be applied to the bio-detection analyzer 1 of the third preferred embodiment having different structure from the first preferred embodiment.

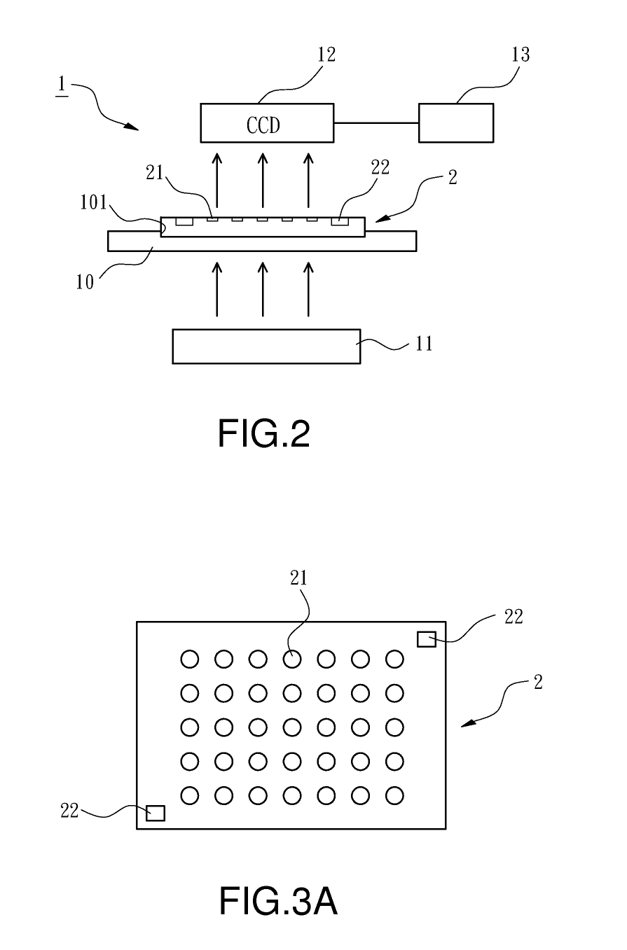

Referring now to FIG. 7, a method for analyzing an image from a bio-detection analyzer according to a fourth preferred embodiment of the present invention is illustrated. As shown, the method of the fourth preferred embodiment is similar to that of the first preferred embodiment, while a bio-detection analyzer 1 of the fourth preferred embodiment is different from that of the first preferred embodiment. The bio-detection analyzer 1 of the fourth preferred embodiment comprises a support base 10, at least one annular light source 11′, an image capturing unit 12, and an image processor 13, wherein the annular light source 11′ is disposed above the support base 10 and surrounding the image capturing unit 12. The annular light source 11′ emits an even light which will be projected to the bio-detection carrier 2 on the support base 10. Then, the even light is reflected from the bio-detection carrier 2 and projected upward to the image capturing unit 12. Furthermore, the bio-detection analyzer 1 can be preferably provided with a plurality of lenses or reflection mirrors (not-shown) between the annular light source 11′ and the image capturing unit 12 for suitably expanding, concentrating, refracting, or reflecting the even light of the annular light source 11′. As a result, the method for analyzing an image from a bio-detection analyzer of the present invention can be applied to the bio-detection analyzer 1 of the fourth preferred embodiment having different structure from the first preferred embodiment. The foregoing bio-detection analyzers 1 of the four preferred embodiments of the present invention, as shown in FIGS. 2, 5, 6, and 7, are only possible embodiments of the present invention without limitation, while the method for analyzing an image from a bio-detection analyzer of the present invention can be also applied to other the bio-detection analyzers 1 having different structure.

As described above, the traditional method for analyzing an image from a bio-detection analyzer which captures each image section of each of detection spots in turn and executes an image analysis process thereto, so that the detection efficiency is relatively low and the entire structure is relatively complicated. In comparison, the method for analyzing an image from a bio-detection analyzer of the present invention, as shown in FIG. 1, the single image 3 of the reacted bio-detection carrier 2 is captured for directly executing an image positioning process, an area calculation process, and an intensity analysis process, so as to be advantageous to simplify the entire structure, enhance the detection efficiency, lower the detection cost, increase the detection convenience, increase the detection accuracy, improve the detection reliability, and increase the detection objectivity.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method for analyzing an image from a bio-detection analyzer, comprising:
illuminating a reacted bio-detection carrier having at least one detection spot and at least one positioning spot by at least one light source;
capturing a single image of the bio-detection carrier having all of detection-spot images and positioning-spot images by an image capturing unit;
defining a reference coordinate location of each of the detection-spot images according to the positioning-spot image;
defining an effective detection area of each of the detection-spot images according to the reference coordinate location of each of the detection-spot images; and
analyzing an averaged intensity value of each of the detection-spot images, so as to output the averaged intensity value for showing a reaction result of the reacted bio-detection carrier.

2. The method of claim 1, wherein the averaged intensity value is an averaged gray scale value.

3. The method of claim 1, further comprising: saving a comparison sample image in advance for being compared with the single image, so that the reference coordinate location of the positioning-spot image of the image can be determined according to the comparison sample image, and the reference coordinate location of each of the detection-spot image can be determined according to the reference coordinate location of the positioning-spot image.

4. The method of claim 3, further comprising: searching an adjacent region of an originally predetermined positioning-spot location in the image to find an actual coordinate location of the positioning-spot image in the image, if there is a distance deviation between the actual coordinate location of the positioning-spot image of the image and the predetermined positioning-spot location of the comparison sample image.

5. The method of claim 1, wherein the reference coordinate location of each of the detection-spot image represents a location of a predetermined geometric center or a range of a predetermined maximum detection area.

6. The method of claim 1, further comprising: defining an outermost boundary of each of the detection spots according to a predetermined intensity variation standard, so as to calculate the actually effective detection area thereof.

7. The method of claim 1, further comprising: sampling a plurality of sampling points or all of the sampling points from the effective detection area of each of the detection spots, so as to obtain a plurality of intensity values for executing an average calculation to generate the averaged intensity value of each of the detection spots.

8. The method of claim 1, further comprising a support base for supporting the illuminated bio-detection carrier.

9. The method of claim 8, wherein the support base is provided with at least one positioning recess or at least one positioning protrusion for initially positioning the bio-detection carrier.

10. The method of claim 1, wherein the light source is selected from a daylight lamp, a fluorescent lamp, a laser light source, or a light emitting diode (LED) light source.

11. The method of claim 1, wherein the image capturing unit is selected from a charge coupled device (CCD) sensor or a complementary metal-oxide semiconductor (CMOS) sensor.

12. The method of claim 1, wherein the bio-detection carrier is selected from a bio-detection assay paper or a biochip, which can generate color variation after be reacted.

13. The method of claim 1, wherein each of the detection spots on the bio-detection carrier is dropped with a detection probe in advance, and a coloration principle of the detection probe is selected from a calorimetric tag, a fluorescent tag, or a chemi-luminescent tag.

14. The method of claim 1, wherein the positioning spot is disposed on the bio-detection carrier by a mode of high-concentration dye spot, high-concentration fluorescent tag, protrusion, recess, or printing, so as to provide a reference coordinate for positioning each of the detection spots.

15. The method of claim 1, wherein the positioning spot is disposed on at least one corner or at least one side edge of the bio-detection carrier.

16. The method of claim 15, wherein the number of the positioning spots is two, and the positioning spots are disposed on two diagonal corners of the bio-detection carrier, respectively, for providing a cross positioning arrangement.

17. The method of claim 15, wherein the number of the positioning spots is three, and the positioning spots are disposed on three corners of the bio-detection carrier, respectively, for providing a triangular positioning arrangement.

18. The method of claim 15, wherein the number of the positioning spots is three, and the positioning spots are disposed on three continuous spots in the same row or column of the bio-detection carrier, respectively, for providing a tri-point positioning arrangement.
